(19) United States
(12) Patent Application Publication
(10) Pub. No.: US 2025/0333029 A1
(43) Pub. Date: Oct. 30, 2025

(54) Automatic Express Washing Pod

(71) Applicant: John Denton, Hitchcock, TX (US)

(72) Inventor: John Denton, Hitchcock, TX (US)

(21) Appl. No.: 19/192,657

(22) Filed: Apr. 29, 2025

Related U.S. Application Data
(60) Provisional application No. 63/640,598, filed on Apr. 30, 2024.

(51) Int. Cl. B60S 3/04; B08B 3/04; B08B 3/14; B08B 13/00; C02F 1/00; C02F 1/50; C02F 1/72; C02F 1/78; C02F 103/44; E04B 1/343

(52) U.S. Cl. CPC B60S 3/04; B08B 3/041; B08B 3/14; B08B 13/00; C02F 1/004; C02F 1/50; C02F 1/722; C02F 1/78; E04B 1/34317; C02F 2103/44; C02F 2303/02

(57) ABSTRACT

Embodiments of a washing pod of the present invention generally include a modular assembly of transportable enclosure components and a washing system compatible therewith. The assembly may be installed on any substantially level location that (1) does not need to be excavated or otherwise prepared and (2) does not need to have a connection to a local sewer system. In one embodiment, the washing system includes a wash collection tray, a touchless wash system, one or more recycled water vessels, one or more pumps, and an above-ground water treatment and filtration system. In one aspect, the assembly can typically be installed in a matter of weeks and can be readily disassembled and relocated to another desired location. Embodiments of a method of using embodiments of a washing pod of the present invention are also provided.

### CROSS-REFERENCE TO RELATED APPLICATIONS

This application claims the benefit of U.S. Provisional Application No. 63/640,598 filed on Apr. 30, 2024, which application is incorporated herein by reference as if reproduced in full below.

### STATEMENT REGARDING FEDERALLY SPONSORED RESEARCH OR DEVELOPMENT

Not Applicable.

### FIELD OF THE INVENTION

The present invention generally relates to a portable, modular automated vehicle washing system.

### BACKGROUND OF THE INVENTION

Automated vehicle washing stations typically require a fixed location and waste/drainage systems that are connected to local sewer systems. In addition, such vehicle washing stations usually require many months for site preparation and system installation.

### BRIEF SUMMARY OF THE INVENTION

Embodiments of a wash/washing pod of the present invention generally include a modular assembly of transportable enclosure components and a washing system compatible therewith. The assembly may be installed on any substantially level location that (1) does not need to be excavated or otherwise prepared and (2) does not need to have a connection to a local sewer system. In one embodiment, the washing system comprises a wash collection tray, a touchless wash system, one or more water recycle vessels, one or more pumps, and an above-ground water treatment and filtration system. In one aspect, the assembly can typically be installed in a matter of weeks and can be readily disassembled and relocated to another desired location.

### BRIEF DESCRIPTION OF THE DRAWINGS

For a more complete understanding of the present invention, reference is now made to the accompanying drawings, in which:

FIG. 1A is a depiction of an embodiment of a washing pod of the present invention.

FIGS. 1B, 1C and 1D are depictions of various modular sections of an embodiment of a washing pod of the present invention.

FIG. 2 is an overhead view depiction of an embodiment of a washing pod of the present invention showing vehicles entering and exiting the pod.

FIG. 3 is a depiction of an embodiment of site plan and a floor plan of a washing pod of the present invention.

FIG. 4 is a depiction of an embodiment of a water flow scheme of the present invention.

FIG. 5 is a depiction of an embodiment of the wash system of the present invention with respect to vehicles being cleaned thereby.

### DETAILED DESCRIPTION OF EXEMPLARY EMBODIMENTS OF THE INVENTION

The exemplary embodiments are best understood by referring to the drawings, like numerals being used for like and corresponding parts of the various drawings. In the following description of embodiments, orientation indicators such as “top,” “bottom,” “up,’ “down,” “upper,” “lower,” “front,” “back,” etc. are used for illustration purposes only; the invention, however, is not so limited, and other possible orientations are contemplated.

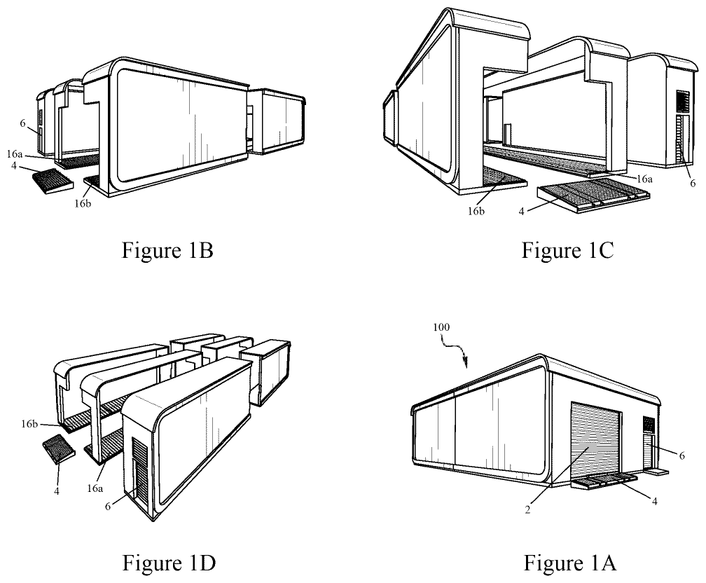

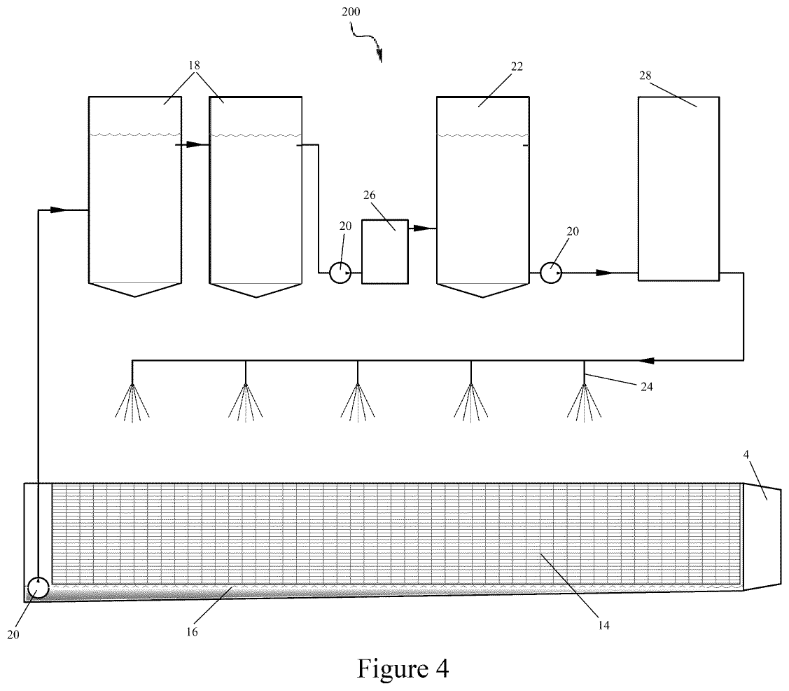

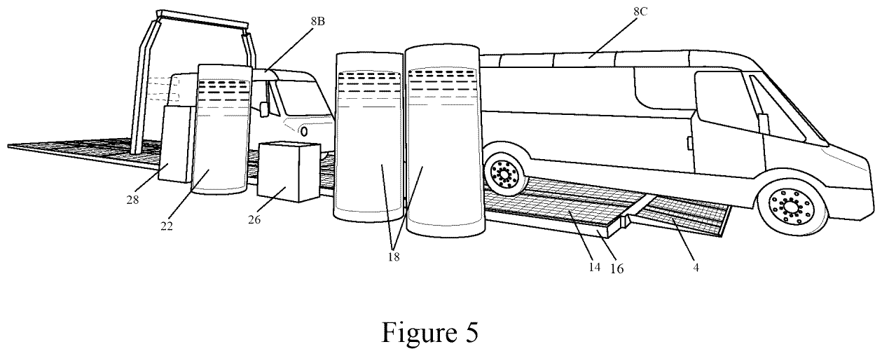

Referring first to FIG. 1A, in one embodiment a washing pod 100 of the present invention comprises a structure adapted and configured for washing vehicles. In one embodiment, a washing pod 100 of the present invention is sized such that commercial package delivery vehicles may be cleaned therewith. As shown in FIGS. 1A-1D, in one embodiment a wash pod 100 may comprise a plurality of modules (not separately labeled) and auxiliary components that can be cooperatively assembled. In one embodiment, one or more of the modules comprises, or can be equipped with, an entrance/exit limiting devices, such as, but not limited to, one or more “garage door” type devices 2. In one embodiment, a washing pod 100 may comprise one or more personnel entries/exits 6 that allows for washing pod 100 attendants to enter and/or exit the structure. In one embodiment, an auxiliary component may comprise one or more ramps 4 that may be positioned at the entrance and/or exit of the washing pod 100. In one embodiment, one or more modules may comprise a component such as, but not limited to, components 16a and 16b depicted in FIGS. 1B, 1C and 1D, that constitutes, or can be combined with other components to constitute, a water collection tray 16, as is shown in FIGS. 4 and 5 described below. In one embodiment, the modules comprise a size and shape that allow for transport thereof by transport vehicles that can travel via public roads. In one embodiment, a washing pod 100 of the present invention is configured to be constructed on any relatively flat surface wherein access to water and electricity is obtainable. In one embodiment, a washing pod 100 of the present invention is adapted and configured to be disassembled and re-assembled in a different location.

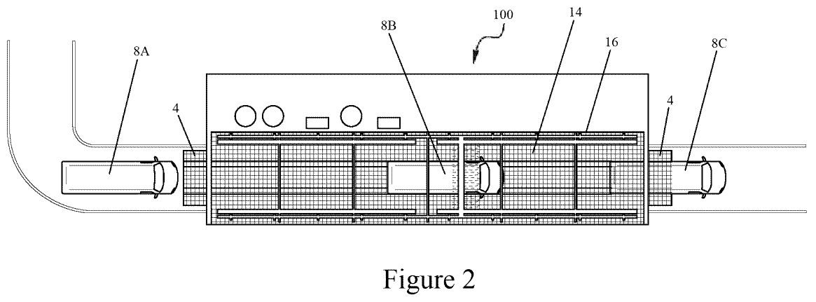

Referring now to FIG. 2, an overhead, partially cutaway view of an embodiment of a washing pod 100 of the present invention shows a substantially enclosed washing venue where vehicles can enter, be washed and exit. In one embodiment, the washing pod 100 houses various wash system components (not separately labeled), shown in greater detail in FIGS. 4 and 5, that provide the water and cleaning agents, as well as handling and purifying of wastewater. In the embodiment of FIG. 2, vehicles 8 accessing the washing pod 100, namely, vehicle 8A entering the washing pod 100, vehicle 8B within the washing pod 100 and vehicle 8C exiting the washing pod 100.

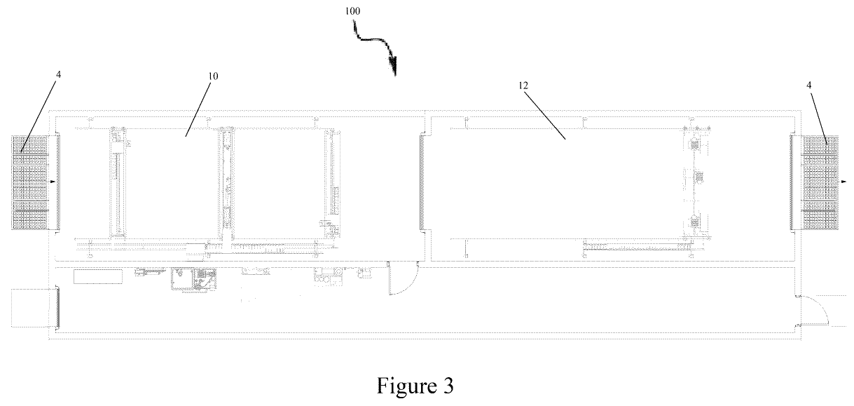

Now referring to FIG. 3, an embodiment of a floor plan of a washing pod 100 of the present invention is depicted. In one aspect, the relative dimensions and size particulars depicted in FIG. 3 are only exemplary and other dimensions, sizes and configurations may be employed, as would be understood by one skilled in the art. In one embodiment, as shown in the floor plan shown in FIG. 3, the washing pod may comprise a wash (washing) chamber 10 and a dry (drying) chamber 12. In other embodiments (not shown), additional washing chambers 10 and/or drying chambers 12 may be employed, and/or one or more washing chambers 10 may be combined with one or more drying chambers 12.

Depicted in FIG. 4 is an embodiment of a water flow scheme 200 of a washing pod 100 of the present invention. In this embodiment, the system comprises a surface-mounted wash pad 14, a water collection tray 16, water recycle/purification vessel(s) 18, pumps 20, a recycled water vessel 22, a chemical treatment module 26 and a wash control system 28 comprising one or more of spray heads 24. In other embodiments (not shown), a washing pod 100 may contain additional components and/or fewer components, as would be understood by one skilled in the art.

In one embodiment, a wash pad 14 comprises a surface (not separately labeled) on which vehicles being washed are positioned during the washing process. In one embodiment, a wash pad 14 comprises one or more orifices through which liquids and some solids may descend during the washing process. In one embodiment, a wash pad 14 may comprise a grating. In one embodiment, a wash pad 14 may comprise metal or other material sturdy enough to support a vehicle being washed. In one embodiment, a water collection tray 16 comprises a water-tight vessel into which water descending through orifices in wash pad 14 may flow. In one embodiment, a wash pad 14 is positioned above a water collection tray 16. In certain embodiments, a wash pad 14 and water collection tray 16 may be connectable, while in other embodiments a wash pad 14 may be integral with a water collection tray 16. In various embodiments, the combination of a wash pad 14 and a water collection tray 16 is sized to provide a minimal vertical displacement. In one aspect, the usage of such a wash pad 14 and a water collection tray 16 allows for water collection/recycle without the need to make or provide sub-surface space available. In one embodiment, a water collection tray 16 is configured such that liquids and entrained solids that descend into the water collection tray 16 gravity flow toward a pump 20 in fluid communication therewith.

In one embodiment, liquids and entrained solids that flow from the water collection tray 16 into the pump 20 fluidly connected thereto are pumped into one or more water treatment vessels 18. In one embodiment, a water treatment vessel 18 may comprise a filtration mechanism (not shown) adapted and configured to remove particulate matter from the composition provided thereto. In addition, a water treatment vessel 18 may be constructed such that solids that sink to the bottom thereof can be removed. In one embodiment, the filtration mechanism comprises one or more filter cartridges. In one aspect, such filter cartridges may be removable and/or replaceable. In one embodiment, a series of water treatment vessels 18 may be employed. In one such embodiment, the water treatment vessels 18 may be positioned and configured such that liquids gravity flow from one water treatment vessel 18 to the next water treatment vessel 18 in the series. In other embodiments (not shown), a plurality of water treatment vessels 18 not fluid communicative in series may be provided. In one aspect, embodiments of a washing pod 100 of the present invention may be operated such that substantially no wastewater is discharged from the washing system and therefore sewer access is not required.

In one embodiment, liquids flowing from one or more water treatment vessels 18 are provided to a pump 20 in fluid communication therewith. In one embodiment, such liquids are pumped thereby through a chemical treatment module 26. In one embodiment, a chemical treatment module 26 is adapted and configured to analyze the liquid provided thereto for undesired components and/or characteristics. In one embodiment, the analysis data obtained via the chemical treatment module 26 is utilized, either automatically or via human input, to add one or more chemical agents to the liquid to neutralize or otherwise chemically rid the liquid of some or all of the undesired components and/or characteristics. In one embodiment, such chemical agents may include oxidizers, such as, but not limited to, ozone and/or peroxides, aqueous acids or bases, deodorizers and/or biocides.

In one embodiment, cleansed water is flowed from the chemical treatment module 26 to one or more recycled water vessels 22. In one aspect, a recycled water vessel 22 may also comprise a means (not shown) for adding fresh water from an outside source thereto to provide an initial supply of water to the washing pod 100 and to supplement the clean water supply during operation thereof. In one embodiment, a recycled water vessel 22 is in fluid communication with a pump 20, such that water therefrom can be pumped into a wash control system 28.

In one embodiment, a wash control system 28 is adapted and configured to provide water and various liquid materials for the cleaning process carried out within the washing pod 100. In one embodiment, such liquid materials comprise alkaline (high pH) detergents, acidic (low pH) detergents, drying agents, ceramic protectants, rust inhibitors, waxes and/or polishes, although the invention is not so limited and other useful vehicle cleaning/treatment materials may be employed, as would be understood by one skilled in the art. In various embodiments, such materials include, but are not limited to, TruPearl™ Shield, TruPearl™ Dry, Golden Knight, Double Vision and Salt Shield commercial products available from Ver-Tech Labs of Rockford, MN.

In one embodiment, a wash control system 28 comprises, or is in informational communication with, a control module (not shown) that, by automated and/or human controlled means, directs such various liquids and liquid mixtures to one or more spray heads 24. In one embodiment, such liquid(s) is/are directed via the spray head(s) 24 at one or more vehicles (not shown in FIG. 4) that are to be cleaned by the washing pod 100. In one embodiment, the liquids directed from the spray head(s) 24 and any materials (e.g., dirt, salt, bird droppings, etc.) washed from the vehicles fall onto the wash pad 14, flow downward therethrough and are collected in the water collection tray 16. Although in the embodiment depicted in FIG. 4 the wash apparatus comprises a “touchless” cleaning method, the invention is not so limited and in other embodiments (not shown), alternative cleaning methods comprising cleaning means that come into physical contact with a vehicle being cleaned may be employed.

In FIG. 5 is shown a view of an embodiment of a logistical vehicle flow scheme of a washing pod 100 of the present invention. In this depiction, only a portion of the components of a washing pod 100 are shown. In the embodiment depicted, a first vehicle 8C is shown exiting the washing pod 100 while a second vehicle 8B is shown within the washing pod 100. While a specific relative positioning of the components of this embodiment is depicted, the invention is not so limited and other positional configurations may be employed. In one aspect, the wash system components may be cooperatively interconnected so as to minimize its footprint.

### Operation

Generally, an embodiment of employing an automatic express washing system of the present invention comprises assembling the washing pod 100 from the modular components and equipping the washing pod 100 with a wash system comprising various components previously described. In one embodiment, once so assembled, a source of electricity and a water source (both not shown) are provided thereto, whereupon vehicles may be introduced thereto for cleaning. In one embodiment, vehicles may be driven through the washing pod 100 to be cleaned, however the invention is not so limited and other means of conveying the vehicles through the wash pod may be employed, as would be understood by one skilled in art.

In various embodiments, dirty vehicles are conveyed through the washing pod 100, wherein water and one or more of the various liquid materials utilized for the cleaning process, as described above, are dispensed such that they forcefully come into contact with the vehicle exteriors, thereby cleaning the vehicle exteriors. In various embodiments, cleaning “stages” may be employed wherein, for example, water may be dispensed in one or more separate stages and the liquid materials may be dispensed in one or more separate stages. In various embodiments, the washing pod 100 may comprise a drying “stage” (see FIG. 3), wherein after the vehicle is washed it is subjected to a drying environment, such as, but not limited to, heat and/or vigorous air flow.

### Method

An exemplary method of utilizing an embodiment of a washing pod of the present invention comprises:
A Washing Pod Provision Step, comprising providing and combining a plurality of washing pod modules to form a washing pod, such as a washing pod 100 as described herein, and fluidly connecting thereto the components of a water flow scheme, such as a water flow scheme 200 as described herein; and
A Vehicle Cleaning Step, comprising conveying a vehicle therethrough, such that water and/or liquid cleaning process materials are directed at the vehicle exterior.

The foregoing method is merely exemplary, and additional embodiments of methods of cleaning a vehicle utilizing embodiments of a washing pod 100 of the present invention consistent with the teachings herein may be employed. In addition, in other embodiments, one or more of these steps may be performed concurrently, combined, repeated, re-ordered, or deleted, and/or additional steps may be added.

The foregoing description of the invention illustrates exemplary embodiments thereof. Various changes may be made in the details of the illustrated construction and process within the scope of the appended claims by one skilled in the art without departing from the teachings of the invention. The present invention should only be limited by the claims and their equivalents.

I claim:

1. A vehicle washing pod, comprising:
a plurality of transportable modules that can be cooperative assembled; and
a washing system configured to dispense water and vehicle exterior treatment agents and recycle water.

2. The automatic washing pod of claim 1, wherein said transportable modules are sized such that they can be transported by standard means on public roads.

3. The automatic washing pod of claim 1, wherein said washing pad is operable without a requirement for sub-surface access.

4. The automatic washing pod of claim 1, wherein said washing pod is sized such that commercial package delivery vehicles may be cleaned therewith.

5. The automatic washing pod of claim 1, comprising a water recycle system that operates with substantially no discharge of wastewater therefrom.

6. The automatic washing pod of claim 5, wherein said water recycle system comprises one or more cartridge filtration components.

7. The automatic washing pod of claim 1, comprising a chemical treatment module that analyses an aqueous recycle stream and can dispense aqueous materials thereinto.

8. The automatic washing pod of claim 7, wherein said chemical treatment module can dispense one or more materials selected from the group consisting of:
oxidizers;
aqueous acids;
aqueous bases;
deodorizers; and
biocides.

9. The automatic washing pod of claim 1, comprising a wash control system that dispenses water and vehicle cleaning/treatment liquids.

10. The automatic washing pod of claim 9, wherein said wash control system can dispense one or more materials selected from the group consisting of:
alkaline (high pH) detergents;
acidic (low pH) detergents;
drying agents;
ceramic protectants;
rust inhibitors;
waxes; and
polishes.

11. A vehicle washing pod, comprising:
a plurality of transportable modules that can be cooperative assembled; and
a washing system configured to dispense water and vehicle exterior treatment agents and recycle water;
wherein:
said transportable modules are sized such that they can be transported by standard means on public roads;
said washing pad is operable without a requirement for sub-surface access;
said washing pod comprises a water recycle system that operates with substantially no discharge of wastewater therefrom;
said washing pod is sized such that commercial package delivery vehicles may be cleaned therewith;
said washing pod comprises a chemical treatment module that analyses an aqueous recycle stream and can dispense aqueous materials thereinto; and
said washing pod comprises a wash control system that dispenses water and vehicle cleaning/treatment liquids.

12. The automatic washing pod of claim 11, wherein said water recycle system comprises one or more cartridge filtration components.

13. The automatic washing pod of claim 11, wherein said chemical treatment module can dispense one or more materials selected from the group consisting of:
oxidizers;
aqueous acids;
aqueous bases;
deodorizers; and
biocides.

14. The automatic washing pod of claim 11, wherein said wash control system can dispense one or more materials selected from the group consisting of:
alkaline (high pH) detergents;
acidic (low pH) detergents;
drying agents;
ceramic protectants;
rust inhibitors;
waxes; and
polishes.

15. A method of washing a vehicle, comprising:
providing the automatic wash pod of claim 1; and
conveying a vehicle therethrough, such that the washing pod is operated to clean said vehicle.

16. The method of washing a vehicle of claim 15, wherein said transportable modules are sized such that they can be transported by standard means on public roads.

17. The method of washing a vehicle of claim 15, wherein said washing pad is operable without a requirement for sub-surface access.

18. The method of washing a vehicle of claim 15, wherein said washing pod comprises a water recycle system that operates with substantially no discharge of wastewater therefrom.

19. The method of washing a vehicle of claim 15, wherein said washing pod comprises a chemical treatment module that analyses an aqueous recycle stream and can dispense aqueous materials thereinto.

20. The method of washing a vehicle of claim 15, wherein said washing pod comprises a wash control system that dispenses water and vehicle cleaning/treatment liquids.
